(19) United States
(12) Patent Application Publication
(10) Pub. No.: US 2003/0074836 A1
(43) Pub. Date: Apr. 24, 2003

(54) Cypress project

(76) Inventor: John Paul Blouin, Loxahatchee, FL (US)

Correspondence Address: John Blouin, 17041 70 St. North, Loxahatchee, FL, 33470, US

(21) Appl. No.: 09/982,090

(22) Filed: Oct. 19, 2001

(51) Int. Cl. A01G 9/02

(52) U.S. Cl. 47/65.9

(57) ABSTRACT

The general ideas of my inventions are to cleanse our environment, as over the last 100 years we have destroyed it with pollutants from chemicals, and products to various hazards that have and will continue to destroy the ozone layer and our atmosphere. We can make this a cleaner environment and a healthier place to live.

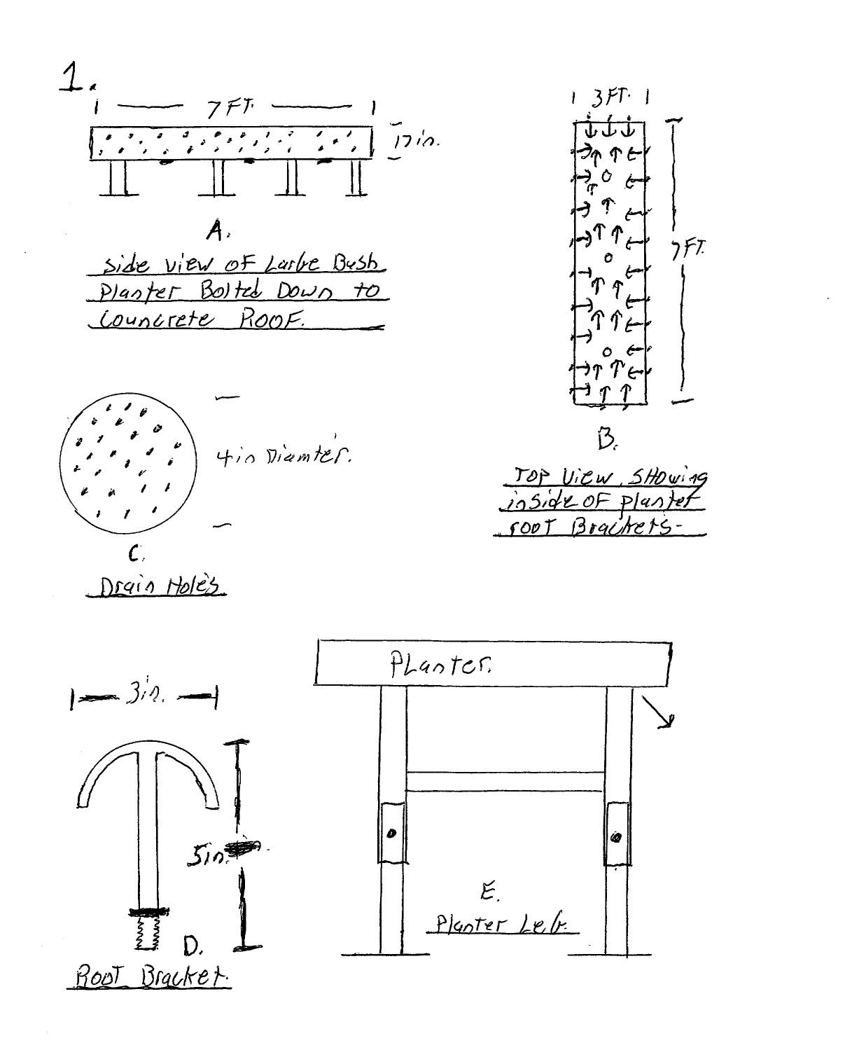

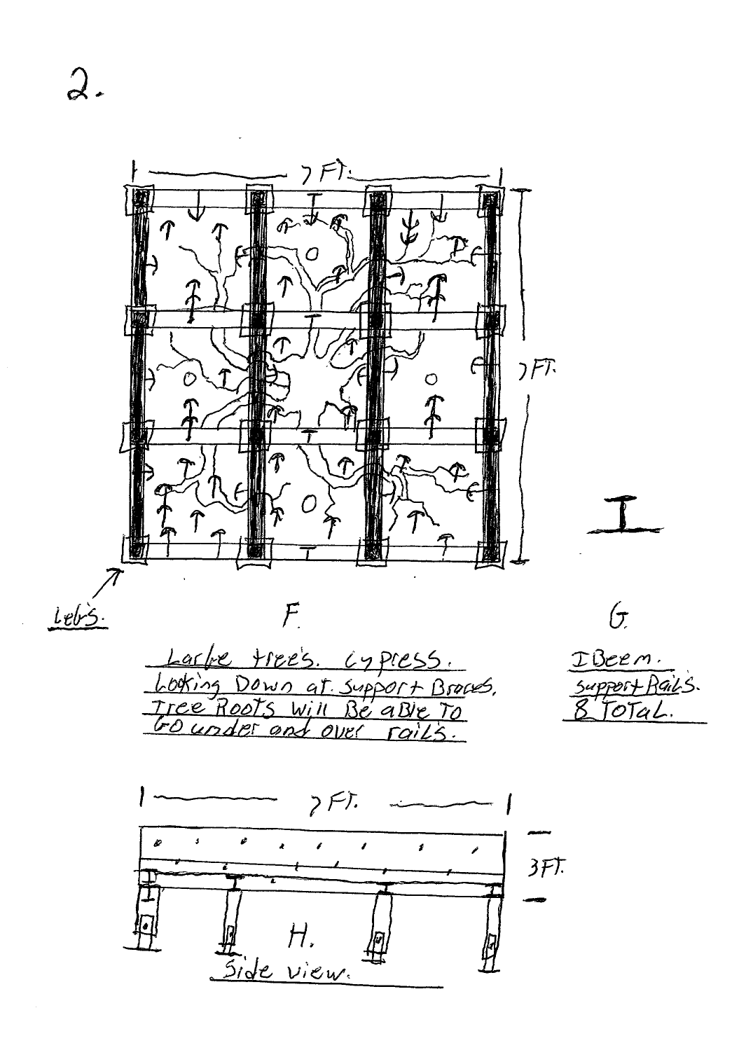

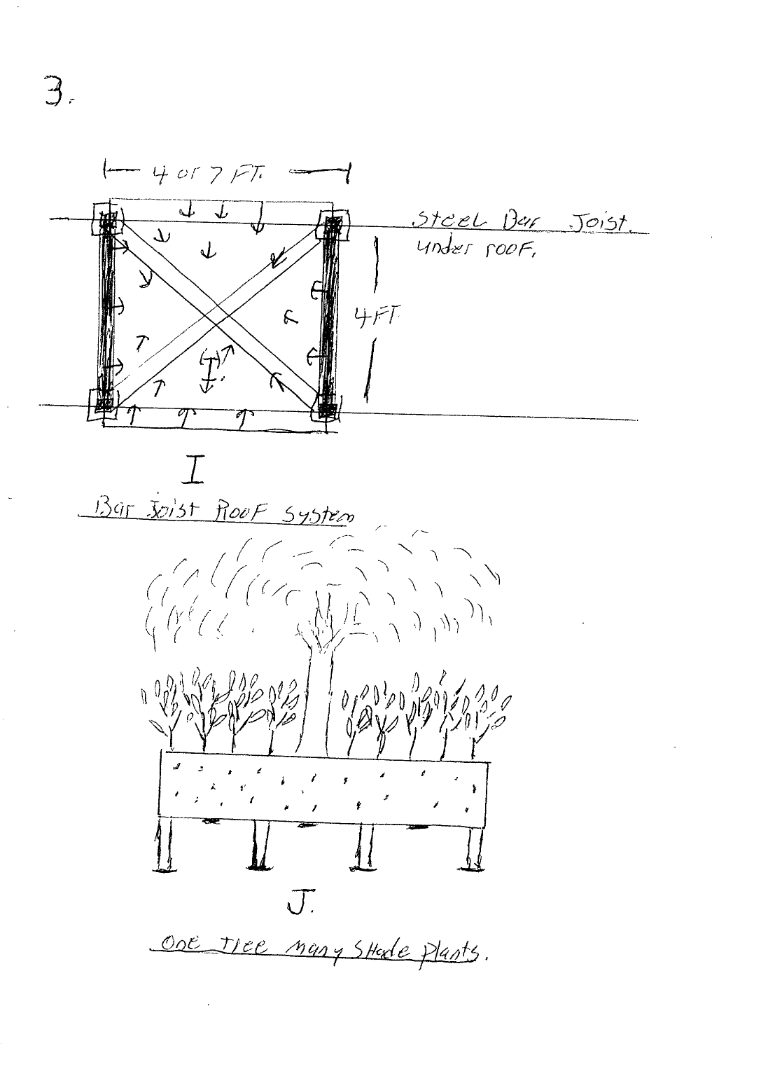

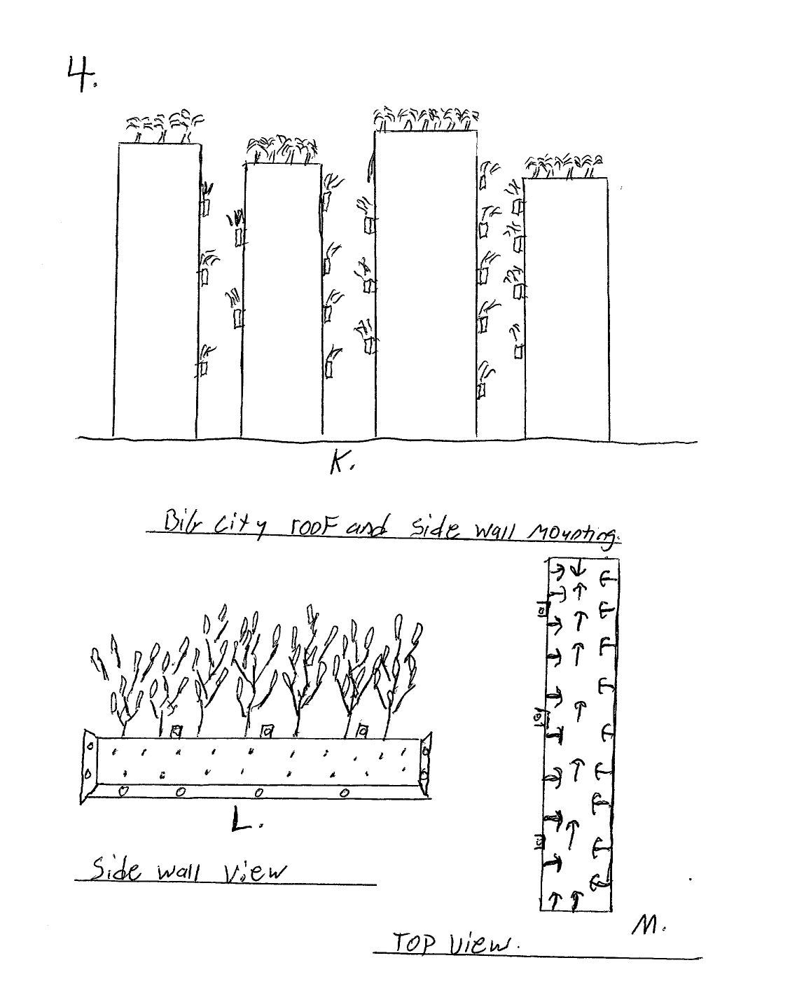

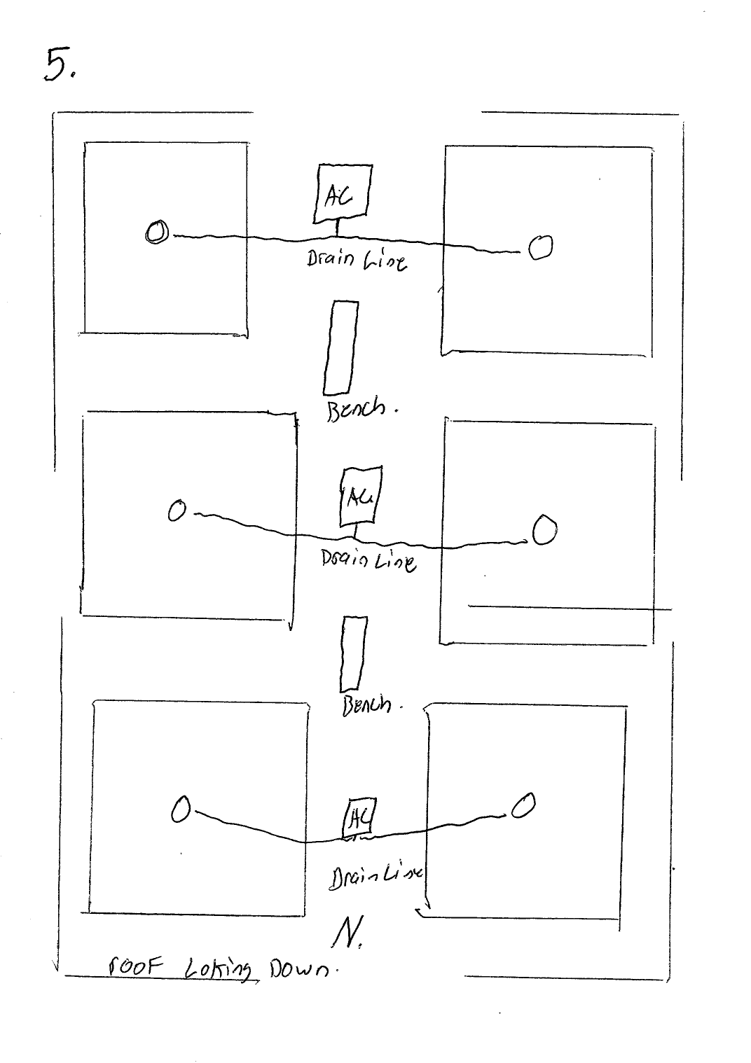

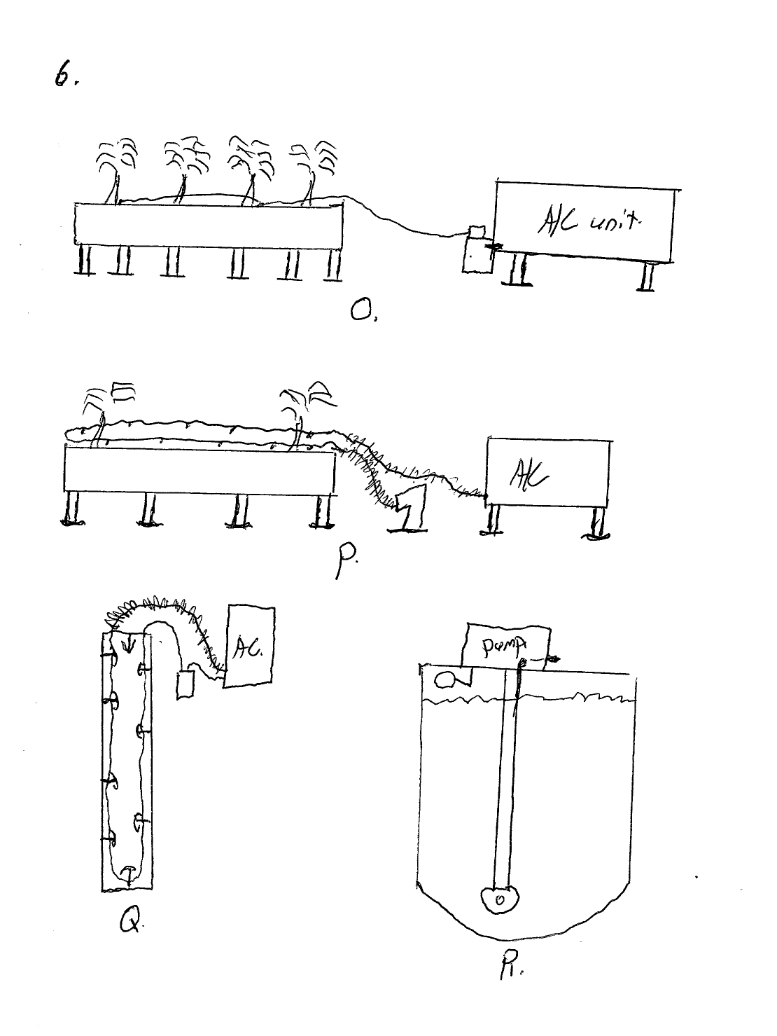

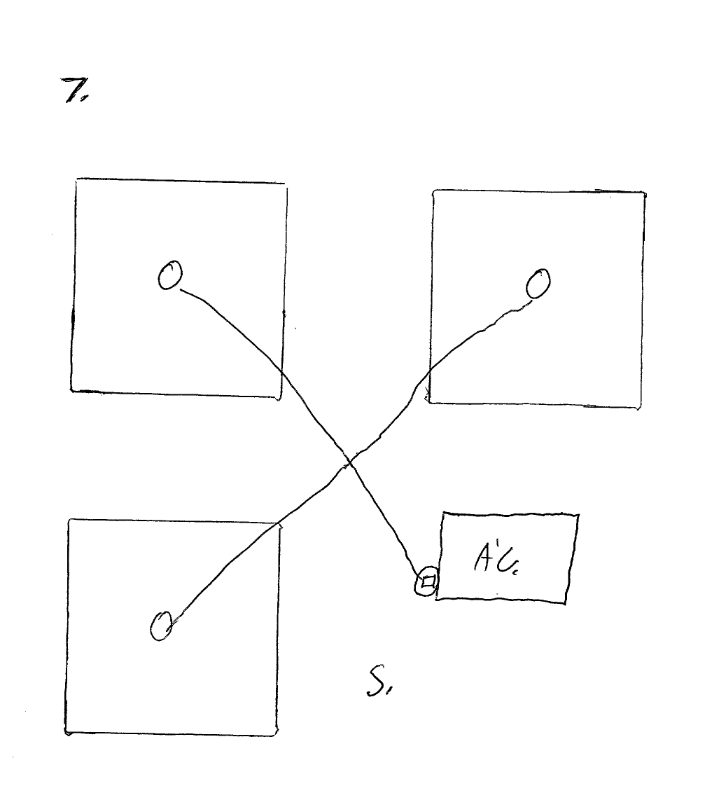

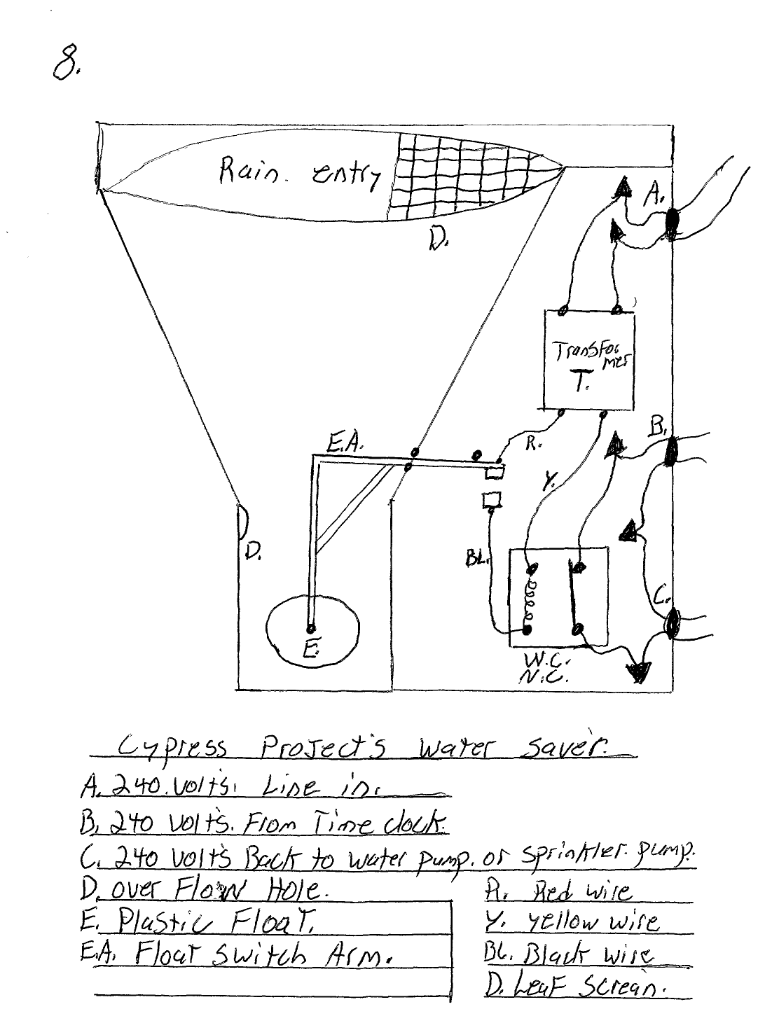

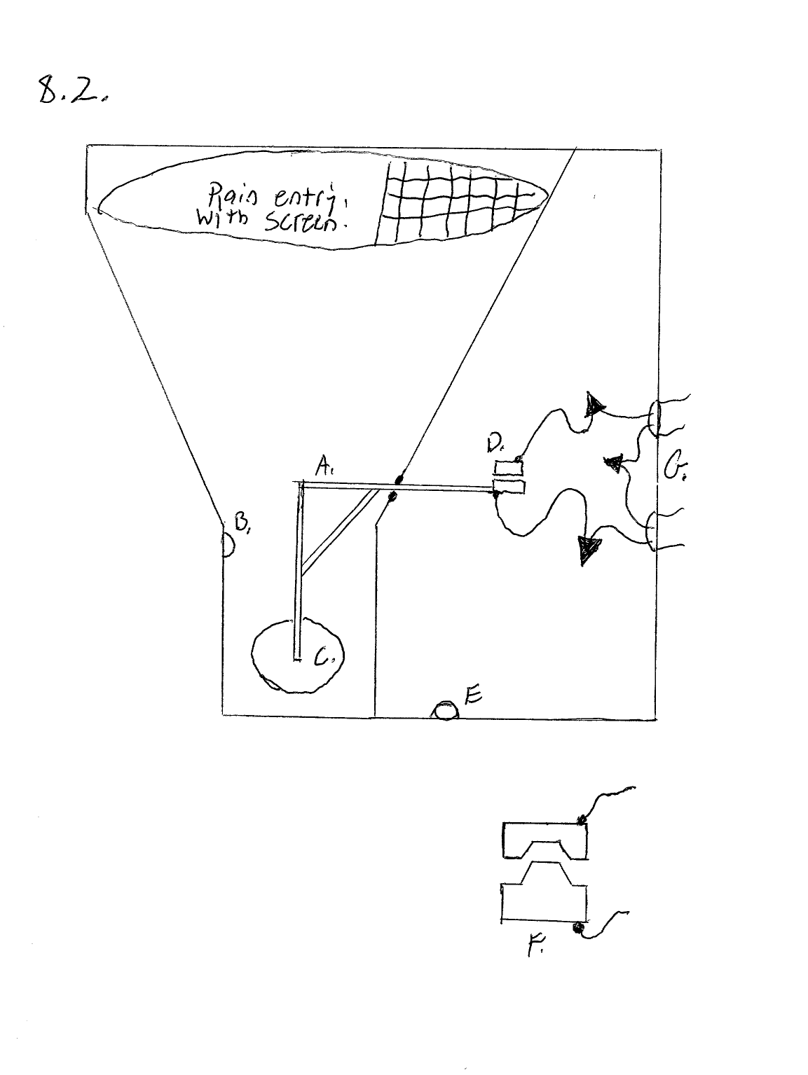

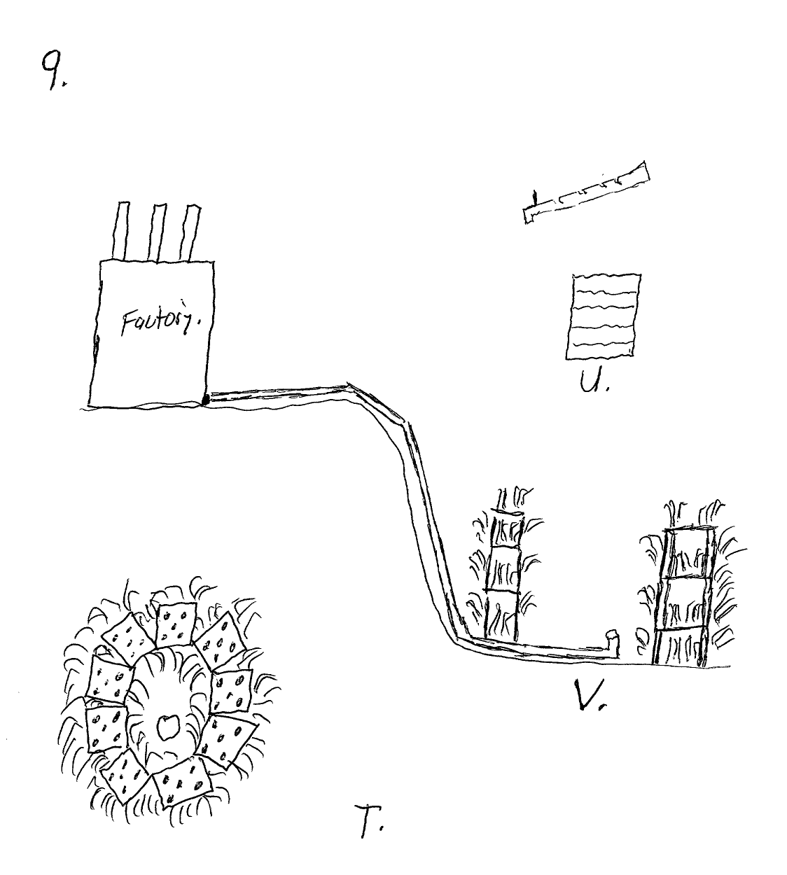

### FIELD OF INVENTION

We all know that plant's play a vital role in the maintenance of life on earth. All energy used by living organisms depends on the complex process of Photosynthesis. The rate of photosipiration has fallen by over 10% in 30 years. One gram of chlorophyll can produce many liters of oxygen per hour and clean the air in the same process.

One of the most serious threats to life is the possibility of rapid warming of the earth. From the accumulation of heat trapping gases, such as air pollution we know is breaking down our ozone layer and the temperature change per decade is .9 to 1.8 degress farenheit.

Plants are the only thing I know of that can clean out the air. They use heat and rays from the sun as food and energy.

### BRIEF SUMMARY

This is where The Cypress Project comes into vision. It is so simple that it is hard to believe we are not already doing it.

I've designed a way to put tree's and plant's on barren roof tops and using the condensate water from the air conditioning to saturate them. The slime and algae will fertilize them. We can also provide shade for the building which will cut down energy usage and is a great insulator.

The most important thing this will do is help clean out the enivironment, for future mankind. Just think of the area we are talking about, whole cities have a great amount buildings, structures, homes for the development of The Cypress Project.

We can construct homes with concrete roof's and parapit walls on them and mount the a/c unit on top, in doing this we can figure out how much pollution the people are causing by their vehicles, household products, lawnmowers, and put the amount of vegetation on the roof top to make up the difference in what they are polluting. Also other trees around there homes would help in the industrial world. We can do the same for factories that pollute the air. We make whole structures specifically designed to hold water and plants.

The ocean can also benefit from The Cypress Project as we can make a structure in a square large area with sea plants all over them as many as needed and the factories pollutants can come right into the middle of the area. This is how big The Cypress Project can or will become.

### DESCRIPTION OF DRAWINGS

My invention is designed with Florida in mind because of hurricanes. Making an aluminum planter that the roots can grasp the inside of it and have legs on it to bolt down to the roof and be able to remove it in hole if we need to reroof the roof from leaks.

If a hurricane hits the trunk will stay but the branches will come off.

I have an article from NASA given to me that has proof in what I am saying. I do not believe we should give up on the outside environment so quickly. What will man do if the other man is working in clean air buildings and the other man has to work outside. Do not let man have the same fate as what we have found on Mars and the Biodome if it is really there.

I have also made a water saver system for roof's that have no a/c units or emergency water in case of a drought. Using a common sprinkler system, the Cypress water saver is deigned to turn the pump off when it rains.

I would like to call the new trades man for this construction The Cypress Tradesman.

Identifying Indicia

A.) Planter will be made out of aluminum, including legs, to be able to last for decades and being bolted down to a concrete roof up to code. I am currently working with an engineer to make sure the plants will stay and the tree trunk will stay in place and only branches will fly off.

B.) Top view showing inside of planter before dirt is added. Showing the root brackets to let the roots grasp them and the 3 drain holes.

C.) Drain holes will be in round to let the water come out 4 inches in diameter.

D.) Root brackets will be made of aluminum from 5 inches long 5/16 wide for bush planters. Tree planters will be be bigger of course 7 inches long to ½thick. Bolted in from the outside after hole is drilled through planter washers will also be used.

E.) Planters legs will be adjustable for different roof thickness and to lift planter up to roof to redoor roof when a leak occurs also all aluminum. Bolts thru legs will be made a stainless steel to be stronger, top of legs to bottom of planter will be welded on all cypress planters. Support rails where necessary.

F.) Large cypress planter for cypress or oak trees. Shown here we have 8 I beems with the darker one's on the bottom of the planter. Spot welded to the planter and the other four placed on top of the other. You will have a 4 inch gap between the I beems going from left to right. Getting the roots. Go under the I beems making the tree stay in place even when a hurricane comes by the building will have to blow down to remove the tree. There will also be shade plant's in the planter around the tree or tree's also the root brackets will be in place to let small roots grasp the cypress planter.

G.) I beem and aluminum rails.

H.) Side view showing inside the planter and leg assembly there will be 16 legs in total.

3.) Bar joist roof application system. Depending on space of bar joices usually 4 ft but large commercial buildings same time have up to 10 ft but will be done with the same engineer drawings to pass florida code which is the toughest code in America.

J.) Side view with tree and plants.

4.K.) New York showing use of The Cypress Project using cypress side wall planters.

L.) Side wall planter being bolted with red head 3/8 concrete bolts or other to hold planter to wall

M.) Inside side wall planter many different sizes will be made depending on the application.

5.) Looking down at a roof showing how an a/c package unit waters the planters all year round and feeds them. Only 2 planters can be fed by one a/c unit to prevent future problems, drain lines clogging. Also on some roofs where stairs and doors provide regular access to the roof. I will make a aluminum bench bolted to the roof. For getaway or to look up to the heavens.

6.) Many planters on only one air conditioner.

O.) A/C unit feeding planter wit a condensate pump attachment with a float switch in it that shuts the a/c unit off. Telling the customer or homeowner to check on there tree's by calling a qualified a/c company.

P.)Suction line condensate watering sideview system. By letting the suction line run along the top of the planter with no installtion which will cause it to seat we will make beads of soder under the suction line and it will drip in that spot. Will probably have to fertilize the planters.

Q.) Top view of suction line condensate watering system

R.) Making a larger condensate pump so it will not clog-up so quickly with slime.

7.) Condensate pump watering many plants.

8.) Cypress project water saver. Desinged for the project that has no air conditioners on roof tops. It will be hooked up to the buildings sprinkler system or put pump and water supply on roof where applicable. It is designed to not over water trees. During the rainy season which when the saver fills up from a storm will cause the float switch to rise cutting power to the sprinkler pump and when it evaporates. The sprinkler time will still be running so only when it rains will it operate by not allowing power from the time to go to the pump motor. It will be able to use on many applications around the world.

8.S) Cypress projects water saver, saver. This one is designed to use without electricity. The rain water goes in and fills the bottom casuing the float switch to rise making a contact open breaking on 240 volt leg to the sprinkler pump. Not letting it come on till the water evaporates.

Table:

A) Plastic float arm

B) Overflow hole

C) Float

D) Contacts

E) Emergency overflow hole

F) Special designed contacts

G) Access holes, Knockout for electricity from pump and back to pump.

9.V) The future of The Cypress Project using the same principle in the oceans as the air. By building a structure in the ocean so when pollutants from factories can emerge right into a weed forest that will start cleaning it out in that immediate area.

T.) Having a parking lot under water many stories with 5 windows in the concrete ceilings to let light shine through the structure with it fill of plant life will also attract ocean life. Yes we can build it on the land next to a factory using the same process.

U.) Making ceramic roof tile with grooves on it so grass can be put on it and grab hold of it and a lip on the bottom edge to hold the dirt from sliding off. I know of certain grasses that do not grow tall. But outward.

1. What I claim as my invention is the process of finding out how much vegetation plantlife we need to put in a designated area to clean out the pollution we have caused by the amount of cars we have in a specific area or lawnmowers, chlorine, carbon dioxide, bleach, hairspray and any other thing we know off that is harmful to the environment. Starting with single family homes, multi family dwellings, commercial properties, whole cities, states, countries and the the world.

2. What I also claim as my invention is the process of finding the way to make a container that will hold plant life and bolt or fasten the container to the structure consisting of houses, building, and bridges, high rises and any structure man has made.

3. What I also claim as my invention is the process of watering the planters with air conditioners, condensate water and heating the planters with either electric or water heaters or using hot gas lines from the a/c system.

4. What I also claim as my invention is the cypress planters themselves that is a planter specifically designed to hold the tree, bush or vegetation in the planter, which will be made of aluminum or any other materials to do the above-mentioned job.

5. I also claim my invention to be the cypress saver and the cypress saver saver, which are devices to shut the water sprinkler off when it rains to prevent overflow.

6. I also claim my invention is making a roof tile that can hold grass roots to it and hold dirt from sliding of the pitched roof.

7. Finally I claim my invention is the name of the New Tradesman. I would like it to be called The Cypress Tradesman.
